(19) United States
(12) Patent Application Publication
(10) Pub. No.: US 2016/0335654 A1
(43) Pub. Date: Nov. 17, 2016

(54) INCENTIVIZING USERS TO COLLECT REAL-WORLD ITEMS AND PROVIDE ITEM RATINGS

(71) Applicant: TrackerTreat, Inc., Milpitas, CA (US)

(72) Inventors: Robert Spencer Giglio, Moraga, CA (US); Chase William Giglio, Moraga, CA (US); Robert Keith Giglio, Moraga, CA (US)

(21) Appl. No.: 14/710,984

(22) Filed: May 13, 2015

(51) Int. Cl. G06Q 30/02; H04L 29/08

(52) U.S. Cl. CPC G06Q 30/0218; H04L 67/10; H04L 67/141

(57) ABSTRACT

Systems and methods for incentivizing users to collect real-world items and provide item ratings are described. Theses examples are applicable to a wide variety of different collection scenarios, including the collection of candies by trick-or-treaters during Halloween, the collection of Girl Scout cookies during the local cookie season, toys (e.g., action figures and Legos characters), and the collection of rare items (e.g., out-of-circulation baseball cards, stamps, and coins). These examples allow users to submit data relating to the items they collect (e.g., item types, item quantities, item collection times, and item collection locations). These examples generate a respective inventory of collected items for each user. The inventories are provided to the users for display on their computing devices. On the basis of data derived from the inventories, the examples provide incentives that are structured to encourage user to collect additional items and submit item ratings.

### BACKGROUND

Several informational services have been proposed to help users to locate real-world items of interest.

For example, a Candy Tracker mobile service (see http://tech.thejoestory.com/2014/10/candy-tracker-finding-sweet-spots.html) enables a trick-or-treater during Halloween to use a mobile device to submit the name of each piece of candy received along with a rating. The Candy Tracker service automatically obtains the GPS coordinates of the location where each candy name was inputted from the mobile devices and posts a map of the logged candy ratings at the logged GPS coordinate locations to enable users of the service to locate Halloween candies of interest.

US Patent Publication No. 2014/0108556 describes another informational service that allows users who have verified their primary residence locations in a neighborhood to publish their property boundaries to one another in a shared map. During Halloween, candy givers can publish candy giving times and the types of candies that they give out from their respective residences to the map. The system provides candy seekers automated verbal navigation guidance describing optimal walking routes to residences offering Halloween candy in the neighborhood through a voice-navigation system of their mobile devices. Candy recipients can post ratings and reviews of the residences from which they received candy to assist other candy seekers in locating Halloween candies of interest.

Systems and methods for incentivizing users to collect real-world items and provide ratings for those items are needed.

### DESCRIPTION OF DRAWINGS

FIG. 1 is a diagrammatic view of an example of a system for incentivizing users to collect real-world items and provide item ratings.

FIG. 2 is a flow diagram of an example of a method of incentivizing users to collect real-world items and provide item ratings.

FIG. 3 is a diagrammatic view of an example of a client network node presenting a user interface.

FIG. 4 is a diagrammatic view of an example of a client network node presenting a user interface.

FIG. 5 is a diagrammatic view of an example of a client network node presenting a user interface.

FIG. 6 is a diagrammatic view of an example of a client network node presenting a user interface.

FIG. 7 is a block diagram of an example of a network node.

### DETAILED DESCRIPTION

In the following description, like reference numbers are used to identify like elements. Furthermore, the drawings are intended to illustrate major features of exemplary examples in a diagrammatic manner. The drawings are not intended to depict every feature of actual examples nor relative dimensions of the depicted elements, and are not drawn to scale.

### I. Definition of Terms

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” (also referred to herein as “memory”) refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, and optical discs, such as DVD-ROM/RAM and CD-ROM/RAM.

A “network node” (also referred to simply as a “node”) is a physical junction or connection point in a communications network. Examples of network nodes include, but are not limited to, a terminal, a computer, and a network switch. A “server node” is a network node that responds to requests for information or service. A “client node” is a network node that requests information or service from a server node.

As used herein, the term “includes” means includes but not limited to, the term “including” means including but not limited to. The term “based on” means based at least in part on.

### II. Incentivizing Users to Collect Real-World Items and Provide Item Ratings

The examples that are described herein provide improved systems and methods for incentivizing users to collect real-world items and provide ratings for those items. The incentivizing examples described herein are applicable to a wide variety of different collection scenarios, including the collection of candies by trick-or-treaters during Halloween, the collection of Girl Scout cookies during the local cookie season, toys (e.g., action figures and Legos characters), and the collection of rare items (e.g., out-of-circulation baseball cards, stamps, and coins). The collected items may be obtained free of charge or purchased. The incentivizing examples described herein allow users to submit data relating to the items they collect. Examples of such data include item types, item quantities, item collection times, and item collection locations. The incentivizing examples described herein generate a respective inventory of collected items for each user. The inventories are provided to the users for display on their computing devices. On the basis of data derived from the inventories, the incentivizing examples described herein provide incentives that are structured to encourage user to collect additional items and submit item ratings.

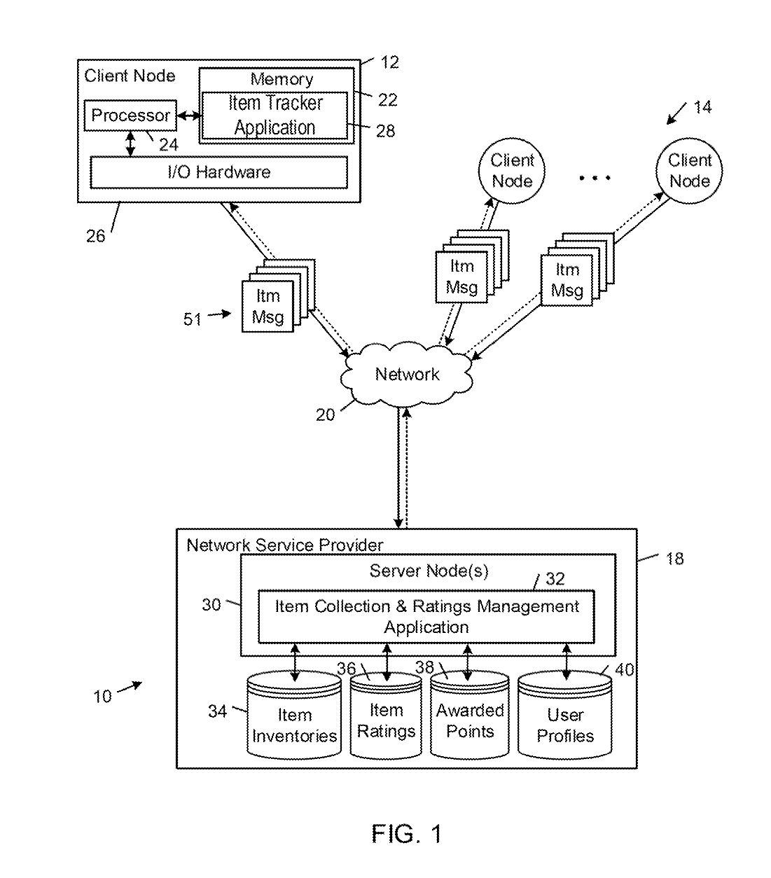

FIG. 1 shows an example of a network communications environment 10 that includes a first client network node 12, one or more other client network nodes 14, and a network service provider 18 that are interconnected by a network 20. The network 20 may include any of a local area network (LAN), a metropolitan area network (MAN), and a wide area network (WAN) (e.g., the internet). The network 20 typically includes a number of different computing platforms and transport facilities that support the transmission of a wide variety of different media types (e.g., text, voice, audio, and video) between network nodes 14 and the network service provider 18.

The first client network node 12 includes a tangible computer-readable memory 22, a processor 24, and input/output (I/O) hardware 26 (including a display). The processor 24 executes at least one network-enabled Item Tracker application 28 that is stored in the memory 22. Each of the other client network nodes 14 typically is configured in substantially the same general way as the first client network node 12, with a tangible computer-readable memory storing at least one communications application, a processor, and input/output (I/O) hardware (including a display). In some examples, the client network nodes 12-14 are personal computing devices, such as mobile computing devices (e.g., mobile telephones, tablet computers, and notebook computers) and desktop computers.

The network service provider 18 includes at least one server network node 30 that includes an item collection and ratings management application 32 that hosts an item collection and ratings management service. In some examples, the item collection and ratings management service is a web service and the users of the client network nodes 12-14 are registered members of the web service who access the service through the network-enabled Item Tracker applications 28 on their respective computing devices 12-14.

The item collection and ratings management service maintains an item inventories database 34, an item ratings database 36, an awarded points database 38, and a user profiles database 40. The item inventories database 34 includes records that describe inventories of items (e.g., physical products, non-physical products, or both physical and non-physical products) that have been collected by respective ones of the users. The item ratings database 36 includes records that describe the item ratings that have been received from respective ones of the users (e.g., a rating of three on a scale of one to five). The awarded points database 38 includes records that describe the points that have been awarded to the users by the service. The user profiles database 40 includes records that identify and describe attributes of the registered users and optionally may include user preference profiles that have been generated for respective ones of the users based on their respective item ratings.

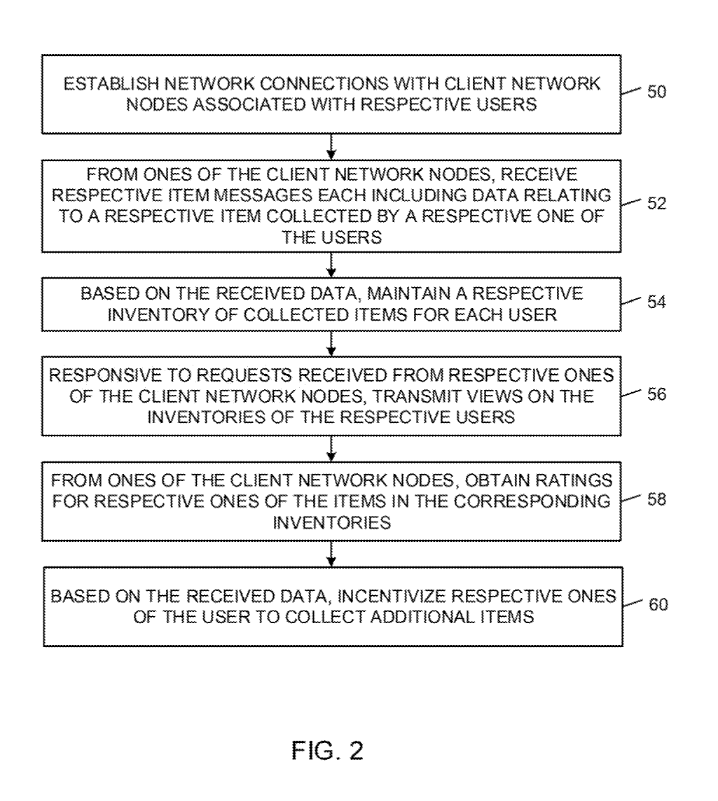

FIG. 2 shows an example of a method performed by the one or more server network nodes 30 implementing the item collection and ratings management service.

In accordance with the method of FIG. 2, the item collection and ratings management service establishes network connections with client network nodes 12-14 that are associated with respective users (FIG. 2, block 50). The connections typically are made between the item collection and ratings management service and the item tracker applications 28 running on the client network nodes 12-14. As explained above, the users typically are registered members of the item collection and ratings management service. During the registration process, a user typically submits to the service information that identifies the user (e.g., user name, age, gender, geographic location). In some examples, the user also may submit to the service information that identifies the user's friends and acquaintances, information that identifies the user's interests (e.g., favorite music, books, movies, sports, foods), and information that specifies other user preferences (e.g., privacy preferences).

As items are collected by the users, the item collection and ratings management service receives from ones of the client network nodes 12-14 respective item messages 51 (see FIG. 1) each of which includes data relating to a respective item collected by a respective one of the users (FIG. 2, block 52). Examples of such data include item type, item quantity, item collection time, and item collection location. In some examples, one or both of the item collection time and item collection location may be obtained by the item tracker application 28 operating on the users' client network nodes 12-14.

Based on the received data, the item collection and ratings management service maintains a respective inventory of collected items for each user (FIG. 2, block 54).

Responsive to requests received from respective ones of the client network nodes, the item collection and ratings management service transmits views on the inventories of the respective users (FIG. 2, block 56). The inventory data can be used to generate a variety of different summary views of a user's item collection. Examples of such views include, a view of the items that have been collected by the user within a particular period of time (e.g., in the last week, in the last month, or in the last year), a view of how much of each type of item that user has collected, and an aggregated view that shows a summary of all the items collected by item type (e.g., 5 Twix, 2 Thin Mint Girl Scout cookies, and 3 McDonalds Happy Meal green cars).

From ones of the client network nodes, the item collection and ratings management service obtains ratings for respective ones of the items in the corresponding inventories (FIG. 2, block 58). In some examples, the item tracker application 28 provides one or more interface elements that allow a user to provide an item rating (e.g., 1-5 stars) in connection with one or more of the inventory views. In some examples, the item collection and ratings management service provides one or more item rating incentives that are designed to encourage users to rate the items in their respective inventories. In some examples, incentives, such as redeemable points and promotions (e.g., coupons), are awarded to users who rate the items in their inventories. In some examples, the amount or type of the incentives that are awarded to users vary according to one or more specified ratings criteria. In some examples, the number of redeemable points awarded or the value of a particular type of promotion awarded varies with the quantity of item rankings provided by the users. For example, the number of points or the value of the promotions increases as a particular user's item ratings exceed specified percentiles of the total number of different types of items in the user's inventor. In some examples, the number of points or the value of the promotions increases with the speed with which the user provides a rating for a particular type of item after the first item of that type was added to the user's inventory.

Based on the received data, the item collection and ratings management service incentivizes respective ones of the user to collect additional items (FIG. 2, block 60). In some examples, the items to be collected are part of a multi-item sets and collection incentives may be structured to encourage users to collect particular ones of the items, collect particular combinations of the items, or collect a complete set of the items. In other examples, the items to be collected are identical and collection incentives may be structured to collect certain quantities of the undifferentiated items. In some examples, the item collection and ratings management service provides item collection incentives in the form of redeemable points or promotions.

In some examples, the item collection and ratings management service encourages users to collect additional items based on structured competitions between users. In these examples, the item collection and ratings management service administers an item collection competition among respective ones of the users. In this process, the item collection and ratings management service typically ascertains a group of the users to compete in the competition. In some examples, the item collection and ratings management service ascertains the group of users based on the geographic locations of the users (e.g., users within a particular geographic region, such as a neighborhood, a public park, or other definable region). During the competition, the item collection and ratings management service tracks the respective realtime inventories of items collected by the users in the group in realtime. The item collection and ratings management service also determines realtime rankings of users in the group based on their respective realtime inventories, sending the realtime rankings to the client network nodes of the users in the group. Based on one or more predefined criteria, the item collection and ratings management service designates one or more of the users in the group as winners of the competition, and awards prizes to the designated users.

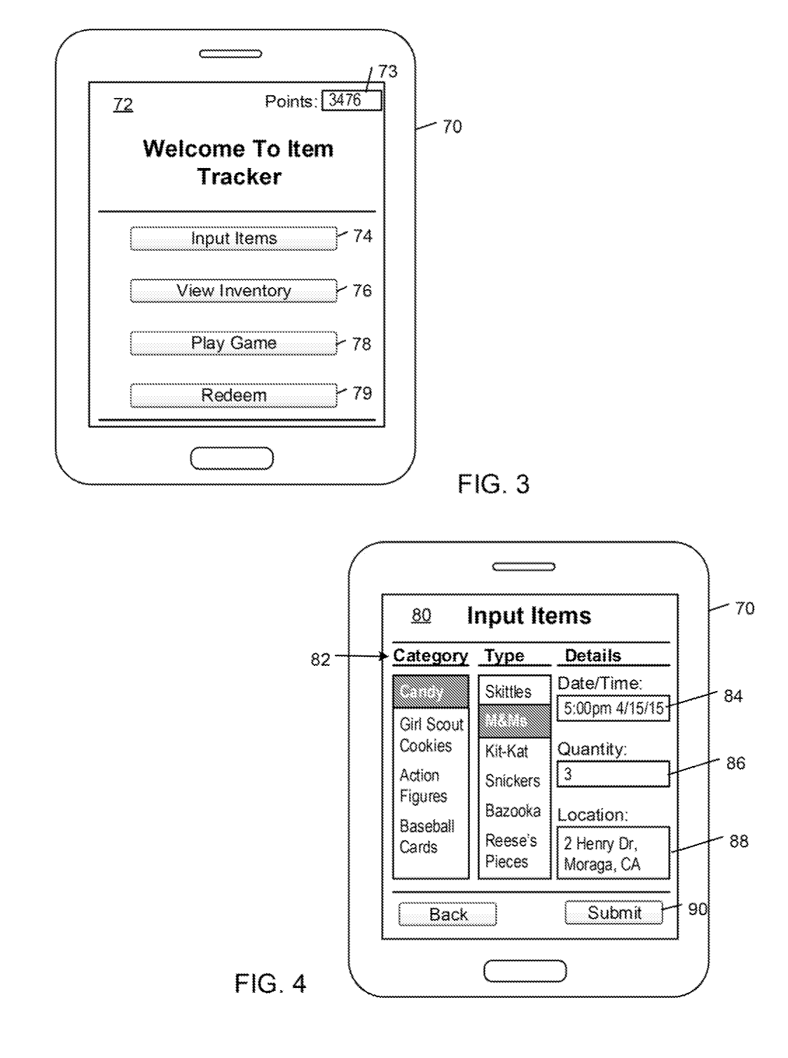

FIGS. 3-6 show exemplary user interfaces that the item tracker application 28 presents to users on their respective client network nodes. In the illustrated examples, the client network node is implemented by a mobile phone 70. The exemplary user interfaces, however, are device independent and may be presented on other types of computing devices.

FIG. 3 shows the mobile phone 70 presenting a home screen 72 of the item tracker application 28. The home screen 72 includes a current points total field 73 that shows the current number of redeemable points that the user has earned. The home screen 72 includes several buttons 74-79 for accessing different functionality of the item tracker application 28. These buttons include an Input Items button 74, a View Inventory button 76, a Play Game button 78, and a Redeem button 79. As explained in detail below, the Input Items button 74 provides access to an interface that enables the user to enter data relating to a collected item, the View Inventory button 76 provides access to an interface that presents one or more views on the user's inventory, and the Play Game button 78 provides access to an interface that presents options for joining an item collection competition. The Redeem button 79 provides access to an interface (not shown) that presents a list of awards (e.g., coupons and other promotions) that have been granted to the user, and options for redeeming points. In some examples, awards and points may be redeemed for physical or virtual products or services.

FIG. 4 shows an Input Items interface 80 that is presented in response to the user's selection of the Input Items button 74 in the home screen interface 72 (FIG. 2). The Input Items interface 80 includes a set of input fields 82 for entering data relating to a collected item, including a Category field, a Type field, and Details fields. The Category field allows the user to select a category corresponding to the collected item to be added to the user's inventory (e.g., Candy, Girl Scout Cookies, Action Figures, and Baseball Cards). In the illustrated example, the user has selected the Candy category (shown highlighted). The category dependent Type field allows the user to select a type of the collected item within the selected category (e.g., Skittles, M&Ms, Kit-Kat, Snickers, Bazooka, Reese's Pieces). In the illustrated example, the user has selected the M&Ms type of candy (shown highlighted). The Details fields allow the user to enter details regarding the selected type of candy, including a collection Date and Time, a Quantity of the selected item type, and a collection Location. In the illustrated embodiment, the user has entered a collection date and time of 5:00 pm on Apr. 15, 2015, a quantity of 3, and a location of 2 Henry Dr., Moraga, Calif. As explained above, in some examples, one or both of the item collection time and item collection location may be obtained automatically by the item tracker application 28 operating on the users' client network nodes 12-14. In these examples, the item tracker application 28 may interface with an application programming interface (API) of the mobile phone 70 to access the current data and time from an operating system component of the mobile phone 70 and the current global positioning system (GPS) coordinates from a GPS component of the mobile phone 70.

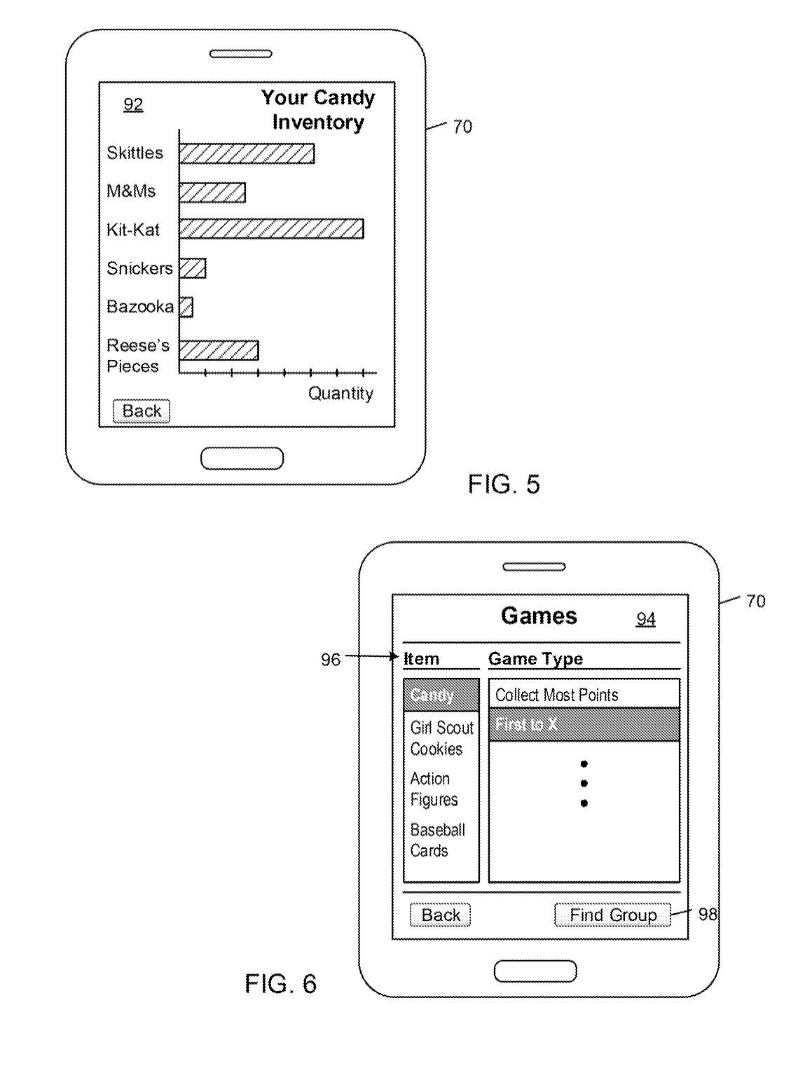

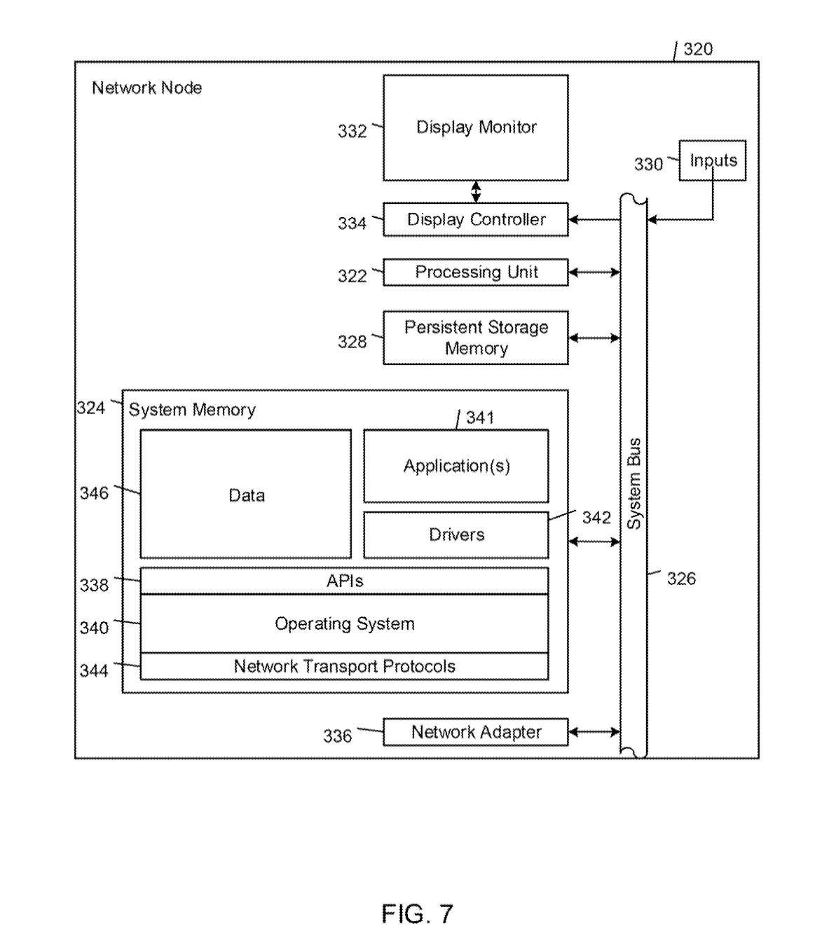

FIG. 5 shows an Inventory interface 92 that is presented in response to the user's selection of the View Inventory button 76 in the home screen interface 72 (FIG. 2). In the illustrated example, the Inventory interface 92 presents a bar graph that shows the quantities of the different types of candy in the user's candy inventory. In some examples, in addition to the illustrated view of quantity by time, the inventory interface 92 provides options for displaying different views on the user's item inventory. Examples of such views include aggregate quantity of all types over time and quantity of a specified type over time.

FIG. 6 shows a Games interface 94 that is presented in response to the user's selection of the Play Game button 78 in the home screen interface 72 (FIG. 2). The Games interface 92 includes a set of input fields 96 for entering data relating to the type of game that the user would like to place, including an Item Category field and a Game Type field. The Item Category field allows the user to select a category corresponding to the item that will be collected in the game (e.g., Candy, Girl Scout Cookies, Action Figures, and Baseball Cards). The item category dependent Game Type field allows the user to select a game type. Examples of different types of games include Collect Most Points and First to×. In a Collect Most Points type of game, the users compete to collect the most points during a particular period of time, where different items that can be collected may be associated with different numbers of points that can be earned (e.g., a Snickers may increase a user's point total by three points, whereas a Bazooka may increase a user's point total by five points). In a First to× type of game, the users compete to collect× number of items of a particular type (e.g., 10 M&Ms).

After the user has selected the type of game to be played, the user may select a Find Group button 98 to initiate a game. In response to the selection of the Find Group button 98, the item collection and ratings management service ascertains a group of users to play the game. In some examples, the item collection and ratings management service may present the user with a list of currently active games to join in response to the user's selection of the Find Group button 98. In some examples, the item collection and ratings management service may initiate a new game in response to the user's selection of the Find Group button 98. In this process, the item collection and ratings management service may send out invitations to join the game to all users or a particular subset of the users (e.g., users within a particular geographic region or time zone, or users who are listed as friends of the game initiating user's profile). Other variations are possible.

### III. Exemplary Network Nodes

Users typically access a network communication environment from respective network nodes. Each of these network nodes typically is implemented by a general-purpose computer system or a dedicated communications computer system (or “console”). Each network node executes communications processes that connect with one or both of the product recommendation provider and the network service provider.

FIG. 8 shows an exemplary example of a client network node that is implemented by a computer system 320. The computer system 320 includes a processing unit 322, a system memory 324, and a system bus 326 that couples the processing unit 322 to the various components of the computer system 320. The processing unit 322 may include one or more data processors, each of which may be in the form of any one of various commercially available computer processors. The system memory 324 includes one or more computer-readable media that typically are associated with a software application addressing space that defines the addresses that are available to software applications. The system memory 324 may include a read only memory (ROM) that stores a basic input/output system (BIOS) that contains start-up routines for the computer system 320, and a random access memory (RAM). The system bus 326 may be a memory bus, a peripheral bus or a local bus, and may be compatible with any of a variety of bus protocols, including PCI, VESA, Microchannel, ISA, and EISA. The computer system 320 also includes a persistent storage memory 328 (e.g., a hard drive, a floppy drive, a CD ROM drive, magnetic tape drives, flash memory devices, and digital video disks) that is connected to the system bus 326 and contains one or more computer-readable media disks that provide non-volatile or persistent storage for data, data structures and computer-executable instructions.

A user may interact (e.g., input commands or data) with the computer system 320 using one or more input devices 330 (e.g. one or more keyboards, computer mice, microphones, cameras, joysticks, physical motion sensors such Wii input devices, and touch pads). Information may be presented through a graphical user interface (GUI) that is presented to the user on a display monitor 332, which is controlled by a display controller 334. The computer system 320 also may include other input/output hardware (e.g., peripheral output devices, such as speakers and a printer). The computer system 320 connects to other network nodes through a network adapter 336 (also referred to as a “network interface card” or NIC).

A number of program modules may be stored in the system memory 324, including application programming interfaces 338 (APIs), an operating system (OS) 340 (e.g., the Windows® operating system available from Microsoft Corporation of Redmond, Wash. U.S.A.), software applications 341 including the network enabled application 28, drivers 342 (e.g., a GUI driver), network transport protocols 344, and data 346 (e.g., input data, output data, program data, a registry, and configuration settings).

In some examples, the one or more server network nodes 30 of the network service provider 18 are implemented by respective general-purpose computer systems of the same type as the client network node 320, except that each server network node typically includes one or more server software applications.

In other examples, the one or more server network nodes 30 of the network service provider 18 are implemented by respective network devices that perform edge services (e.g., routing and switching).

### IV. Conclusion

The examples that are described herein provide improved systems and methods for incentivizing users to collect real-world items and provide item ratings.

Other examples are within the scope of the claims.

1. A method performed by one or more server network nodes hosting a network service, the method comprising:
establishing network connections with client network nodes associated with respective users;
from ones of the client network nodes, receiving respective item messages each comprising data relating to a respective item collected by a respective one of the users;
based on the received data, maintaining a respective inventory of collected items for each user;
responsive to requests received from respective ones of the client network nodes, transmitting views on the inventories of the respective users;
from ones of the client network nodes, obtaining ratings for respective ones of the items in the corresponding inventories;
based on the received data, incentivizing respective ones of the user to collect additional items, wherein the incentivizing comprises rewarding ones of the users based on an evaluation of the items in their respective inventories and rewarding ones of the users based on submission of ratings for one or more of the items in their respective inventories.

2. The method of claim 1, wherein each of respective ones of the item messages comprises a user identifier assigned to the respective user, item distinguishing information.

3. The method of claim 2, wherein each of respective ones of the item messages further comprises item collection time information

4. The method of claim 2, wherein each of respective ones of the item messages further comprises item collection geographic location information.

5. The method of claim 1, wherein the transmitting comprises transmitting a view of items collected over time.

6. The method of claim 1, wherein the transmitting comprises transmitting a view of items collected by item type.

7. The method of claim 1, wherein the obtaining comprises collecting the ratings from respective ones of the user in connection with the transmitted views.

8. The method of claim 1, wherein the obtaining comprises collecting the ratings from respective ones of the users in connection with user interface elements provided on the client network nodes for inputting data relating to items collected by the respective users.

9. The method of claim 1, further comprising aggregating ratings obtained from respective ones of the client network nodes by item type.

10. The method of claim 9, further comprising sending aggregated ratings for one or more item types to respective ones of the client network nodes.

11. The method of claim 1, wherein the incentivizing comprises administering an item collection competition among respective ones of the users.

12. The method of claim 11, wherein the administering comprises ascertaining a group of the users to compete in the competition.

13. The method of claim 12, wherein the ascertaining is based on ascertained geographic locations of the users.

14. The method of claim 12, wherein the administering comprises tracking respective realtime inventories of items collected by the users in the group in realtime.

15. The method of claim 14, wherein the administering comprises determining realtime rankings of users in the group based on their respective realtime inventories.

16. The method of claim 15, wherein the administering comprises sending the realtime rankings to the client network nodes of the users in the group.

17. The method of claim 15, wherein the administering comprises naming a respective one of the users in the group as a winner of the competition, and awarding a prize to the named user.

18. The method of claim 1, wherein the rewarding comprises awarding redeemable points to respective ones of the users based on an evaluation of the items in their corresponding inventories.

19. The method of claim 1, wherein the rewarding comprises awarding redeemable points to respective ones of the users based on submission of ratings for respective ones of the items in their corresponding inventories.

20. Apparatus, comprising
non-transitory memory storing processor-readable instructions, and
a processor coupled to the memory, operable to execute the instructions, and based at least in part on the execution of the instructions operable to perform operations comprising:
establishing network connections with client network nodes associated with respective users;
from ones of the client network nodes, receiving respective item messages each comprising data relating to a respective item collected by a respective one of the users;
based on the received data, maintaining a respective inventory of collected items for each user;
responsive to requests received from respective ones of the client network nodes, transmitting views on the inventories of the respective users;
from ones of the client network nodes, obtaining ratings for respective ones of the items in the corresponding inventories;
based on the received data, incentivizing respective ones of the user to collect additional items.
